(19) United States
(12) Patent Application Publication
(10) Pub. No.: US 2021/0406461 A1
(43) Pub. Date: Dec. 30, 2021

(54) ELECTRONIC DATA PLATFORM FOR A TESTING ENVIRONMENT

(71) Applicant: TOYOTA RESEARCH INSTITUTE, INC., Los Altos, CA (US)

(72) Inventors: Ha-Kyung KWON, Sunnyvale, CA (US); Chirranjeevi BALAJI GOPAL, San Jose, CA (US)

(73) Assignee: TOYOTA RESEARCH INSTITUTE, INC., Los Altoss, CA (US)

(21) Appl. No.: 16/917,588

(22) Filed: Jun. 30, 2020

(51) Int. Cl. G06F 40/205; G06F 40/279; G06K 9/62; G06N 3/08; G06F 9/445

(52) U.S. Cl. CPC G06F 40/205; G06F 40/279; G06F 9/445; G06N 3/08; G06K 9/6256

(57) ABSTRACT

A method performed by a computing device includes generating a template for receiving data based on a type of a test conducted in a testing environment. The method also includes receiving data input to the computing device based on the template. The method further includes parsing the received data to identify data corresponding to a sample-based provenance and a time-based provenance. The method still further includes updating at least one of the time-based provenance and the sample-based provenance based on the identified data. The method also includes generating an inference at a machine learning model based on at least one of the time-based provenance and the sample-based provenance, and updating the template based on the inference.

### BACKGROUND

### Field

Certain aspects of the present disclosure generally relate to data storage and retrieval, more specifically, certain aspects of the present disclosure relate to systems and methods for an electronic data platform.

### Background

In a laboratory or research setting, an electronic data platform may capture a researcher's observations while performing experiments (e.g., tests) in a laboratory environment. Conventional electronic data platforms include input components, such as electronic lab notebook (ELN), for providing forms with predefined fields for capturing the observations. It is desirable to improve electronic data platform to provide personalization, reduce an amount of time for capturing observations, and/or improve a process for performing experiments in a testing environment.

### SUMMARY

In one aspect of the present disclosure, a method is disclosed. The method includes generating a template for receiving data based on a type of a test conducted in a testing environment. The method further includes receiving data input based on the template. The method still further includes parsing the received data to identify data corresponding to a sample-based provenance and a time-based provenance. The method also includes updating one or more if the time-based provenance and the sample-based provenance based on the identified data. The method further includes generating an inference at a machine learning model based on one or more of the time-based provenance and the sample-based provenance. The method additionally includes updating the template based on the inference.

In another aspect of the present disclosure, a non-transitory computer-readable medium with non-transitory program code recorded thereon is disclosed. The program code is executed by a processor and includes program code to generate a template for receiving data based on a type of a test conducted in a testing environment. The program code also includes program code to receive data input to the computing device based on the template. The program code further includes program code to parse the received data to identify data corresponding to a sample-based provenance and a time-based provenance. The program code also includes program code to update one or more if the time-based provenance and the sample-based provenance based on the identified data. The program code further includes program code to generate an inference at a machine learning model based on one or more of the time-based provenance and the sample-based provenance. The program code additionally includes program code to update the template based on the inference.

Another aspect of the present disclosure is directed to an apparatus. The apparatus having a memory, one or more processors coupled to the memory, and instructions stored in the memory. The instructions being operable, when executed by the processor, to cause the apparatus to generate a template for receiving data based on a type of a test conducted in a testing environment. The instructions also cause the apparatus to receive data input to the computing device based on the template. The instructions additionally cause the apparatus to parse the received data to identify data corresponding to a sample-based provenance and a time-based provenance. The instructions further cause the apparatus to update one or more if the time-based provenance and the sample-based provenance based on the identified data. The instructions still cause the apparatus to generate an inference at a machine learning model based on one or more of the time-based provenance and the sample-based provenance. The instructions still yet further cause the apparatus to update the template based on the inference.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1A illustrates an example of input screen for an electronic lab notebook (ELN), in accordance with aspects of the present disclosure.

FIG. 1B illustrates a pipeline for performing one or more tests in a laboratory environment according to aspects of the present disclosure.

FIG. 2 illustrates an example of a sample-based provenance according to aspects of the present disclosure.

FIG. 3 illustrates an example of a time-based provenance of a workflow according to aspects of the present disclosure.

FIG. 4 illustrates a flow diagram for training a model according to aspects of the present disclosure.

FIG. 5 is a diagram illustrating an example of a hardware implementation for an electronic laboratory notebook according to aspects of the present disclosure.

FIG. 6 illustrates a flow diagram for a method according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Researchers may use electronic data platforms for various purposes, such as capturing observations in a lab setting. Conventional electronic data platform may use electronic lab notebooks (ELNs) to capture observations. The ELNs may be a tablet device or desktop/notebook computer. In most cases, to prevent contamination, ELNs do not leave the lab environment.

In practice, conventional ELNs provide forms with predefined fields for capturing lab observations. These conventional ELNs do not provide a level of personalization available from conventional pen and paper notebooks. Although conventional ELNs may not be personalized, conventional ELNs may reduce an amount of time specified for capturing observations. It is desirable to improve ELNs for providing personalization while further reducing the amount of time for capturing observations.

Aspects of the present disclosure are directed to systems and method capturing and processing data before, during, and/or after an experiment in an environment, such as a laboratory. The systems and methods may be executed via an electronic data platform. The electronic data platform may include multiple components. The components may be interconnected via one or more communication channels, such as a wired and/or wireless network connection, Internet of Things (IoT) channel, and the like.

In one configuration, an ELN may be configured to perform one or more methods, processes, and techniques of the present disclosure. The ELN may be a structured notebook configured to receive user input via a user input device, such as an electronic input device (e.g., smart-pen). The user input may be manually provided, such as via a finger or a gesture. The ELN may also receive data via one or more connections, such as a network connection, and/or sensors (e.g., a temperature sensor). The inputs may be stored in the ELN and/or transmitted to a remote storage device. Aspects of the present disclosure are not limited to executing the electronic data platform on the ELN. The ELN may be one component of a multi-component system. Other components may include, but are not limited to, remote and/or local data servers, laboratory equipment, sensors, communication devices, and/or other types of data processing and/or data storage components.

In some implementations, the ELN may connect to one or more devices in the laboratory to capture ambient conditions, device settings, experiment results, and/or other information. The ELN may connect to one or more devices via one or more communication channels, such as a wireless network connection. The captured data may be stored as metadata and appended to the observations provided by the user. As an example, the ELN connects to one or more Internet-of-things (IoT) devices, such as a smart thermostat, to capture ambient conditions, such as temperature, pressure, and/or airflow.

In one configuration, the ELN may exchange data with a remote storage device via a network connection. Because the ELN is confined to the lab, it is desirable to transmit notes and other data to the remote storage device via a network connection. The data may be transmitted to the remote storage device as a cron-job or in real-time. The digital notes may be time stamped. The process of transmitting digital notes mitigates having to transcribe notes at a later time.

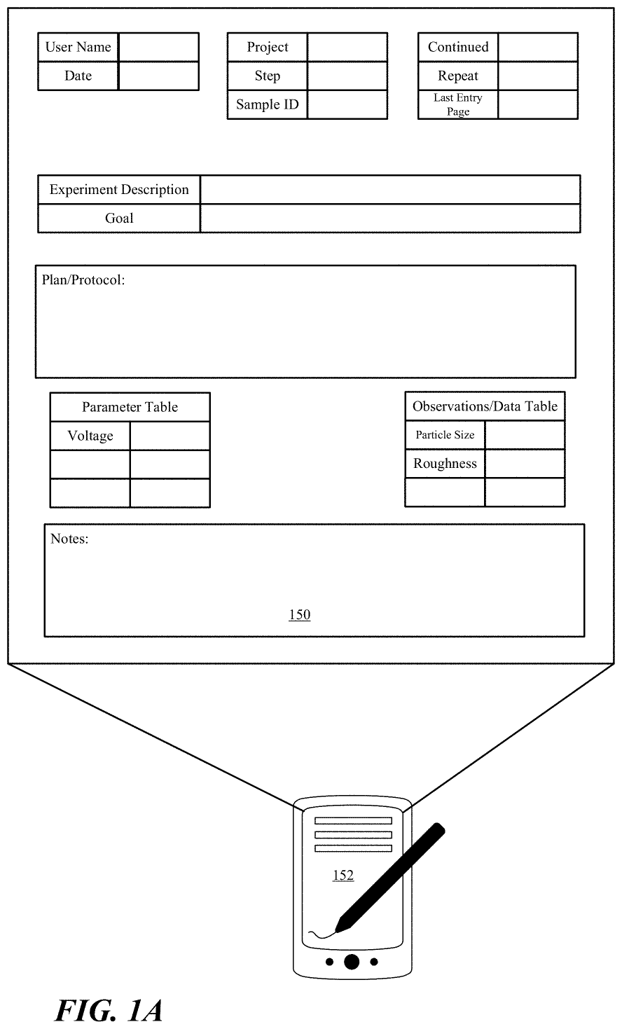

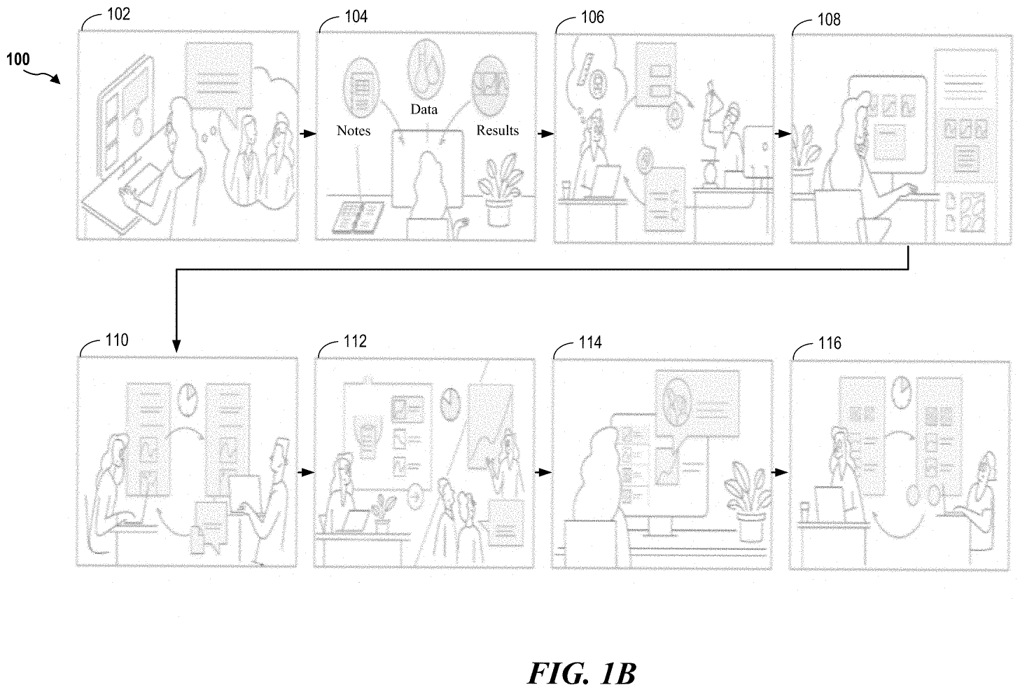

In some implementations, the ELN may include one or more predefined input areas, such as project name, experiment details, parameters, and side notes. The predefined input areas may improve a process for parsing notes. FIG. 1A illustrates an example of input screen 152 for an ELN 150, in accordance with aspects of the present disclosure. The predefined input areas (e.g., fields) of the input screen 152 may be pre-set and/or user-defined. For example, the fields shown in FIG. 1A may be customizable, such that a group may use one or more templates specific to their project and/or technique. Each technique may have a unique parameter table and observation/data table with predefined fields. The parameter table and/or observation/data table may be optional.

As shown in FIG. 1A, a notes field may be provided in the input screen 152. A user may input subjective/personal comments or text in the notes field. The input screen 152 may reference previous experiments and/or data files (not shown in FIG. 1A). Digitized notes can be linked to experiments, and available for proofing by the user.

The notes may be digitized using optical character recognition. The ELN 150 may use protocol-specific parsers for parsing and saving notes to an appropriate format (e.g., table, plot, recipe for mixing, and/or the like). The protocol-specific parsers may parse the notes based on structure and/or context. The ELN 150 may use instrument-specific parsers for parsing and saving data and metadata in a human-accessible structure.

Aspects of the present disclosure are also directed to assisting researchers based on the captured observations. In one configuration, an artificial intelligence (AI) module of the ELN 150 assists researchers based on the received data (e.g., test results, ambient conditions, etc.). In such configurations, the AI module may process lab notes and/or testing data to correct test results, suggest new and/or additional tests, infer test results, and/or the like. The AI module may include one or more trained models. The models may be an artificial neural network, such as a deep convolutional neural network, and/or other types of machine learning models and machine learning functions. Each models may be trained to perform a specific task. The training may be performed offline and updated based on evidence obtained by the ELN 150 in a current laboratory environment.

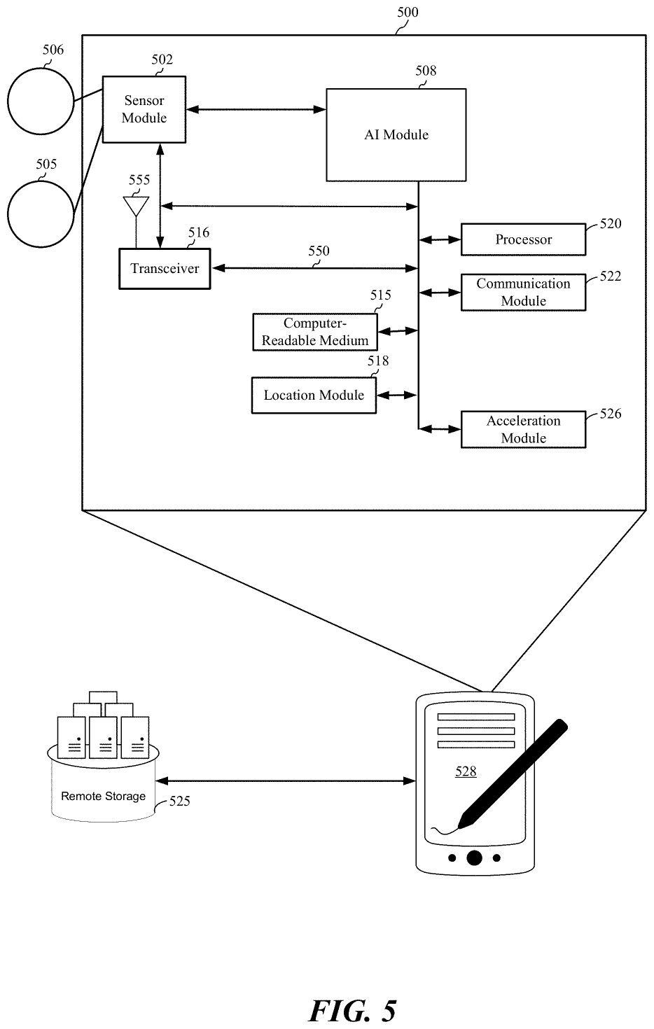

FIG. 1B illustrates a pipeline 100 for a project in a testing environment (e.g., laboratory) according to aspects of the present disclosure. In the example of FIG. 1B, each analyst assigned to a project may use an ELN, such as an ELN 150 or 528 described with reference to FIGS. 1 and 5. The ELN may be a personal ELN (e.g., an ELN assigned to each analyst) or a shared ELN (e.g., an ELN shared between one or more analysts). In some cases, an analyst may be assigned to one or more concurrent projects in a laboratory environment. Each project may be at a different project phase. In the current disclosure, a project is not limited to a specific type of research or laboratory setting. The projects may be directed to different types of research in different types of laboratory settings.

For ease of explanation, the pipeline of FIG. 1 is described with an analyst using an ELN. Aspects of the present disclosure are not limited to an ELN and other components of an electronic data platform may be used for one or more methods and processes described in FIG. 1.

Multiple tests may be conducted during the life of a project. A test may also be referred to as an experiment, an analysis, or the like. The analyst may also be referred to as a researcher, scientist, engineer, experimenter, or the like. For ease of explanation, the laboratory may be referred to as a lab. The lab refers to an environment for conducting tests, experiments, analysis, and the like. Aspects of the present disclosure are not limited to tests in a laboratory. Aspects of the present disclosure may be applied to other types of environments and/or data processing platforms. Additionally, analysts are not limited to researchers, scientists, engineers, experimenters. Other types of analysts are contemplated.

As shown in FIG. 1, at block 102, the analyst initiates a status function for a project management system of an ELN to determine a current status of a previously initiated project. The status function may be initiated via user input provided to the ELN. As described, a project management system of an ELN may manage a number of diverse project streams (e.g., data streams) for a number of concurrent projects assigned to an analyst and/or a team of analysts. Additionally, as described, the analyst concurrently conducts multiple projects, such that the analyst can have an ongoing project if another project is delayed or hits a roadblock. In the example of FIG. 1, the analyst previously initiated a first project, stopped working on the first project, initiated a second project, stopped working on the second project, and is resuming work on the first project (block 102).

In the example of block 102, the analyst may initiate the status function on an ELN and select the first project from a list of projects provided by the status function. The list of projects may include current projects. In some implementations, the list of projects may also include previously completed, related projects, and/or abandoned projects. In response to selecting the first project, the status function may provide an up-to-date report for the first project. The report may include all recorded observations for the project. Additionally, the report may include presentations, notes, reports, and/or other data associated with the first project. Furthermore, the ELN, or a function executed by the ELN, may provide peer feedback received for the data in the report (e.g., observations, presentations, notes, reports, and/or other data).

Additionally, the ELN may provide recent publications corresponding to project tags associated with the selected project. The project tags may be provided by the analysts and/or identified by a project management system executed by the ELN based on the report. For example, the project management system may parse the report to identify terms for the project tags. The parsing may be performed by a parsing artificial neural network (ANN) trained for identifying terms. The parsing ANN may be one of the ANNs of the AI module.

In one configuration, the analyst may select a project tag to view a timeline of a project since its initiation. The timeline may be referred to as the project's evolution. For example, multiple analysts, such as Ph.D. candidates, may have worked on a project since its inception. One or more analysts may leave the project for one or more reasons. Additionally, or alternatively, one or more new analysts may be assigned to the project at different phases of the project's lifetime.

By viewing the evolution, an analyst may determine advances in the test (for example, new knowledge). Such information may assist future decisions. For example, the evolution information may identify a failed experiment. By having information regarding failed experiments, the analyst may know what tests should be performed as well as what tests should not be performed.

In some implementations, the status function provides a list of failed and/or successful protocols for a project. A protocol refers to a series of instructions for a procedure. The procedure may be specified for a synthesis (for example, creating a new material), adding a component to an electrical system, testing a signal, or another type of measurement. For example, one protocol may provide a list of steps for testing signal interference. The failure or success of a protocol may be inferred by the status function and/or expressly provided by an analyst associated with the test.

According to aspects of the present disclosure, the analyst inputs test results and/or corresponding notes to the ELN. The test results and corresponding notes may be provided (for example, input by the analyst) in fields of a template displayed on the ELN. The template may be dynamic, such that the fields may be adjusted based on a type of test to be performed. For example, for material synthesis, one of the fields may request a recipe. As another example, for signal analysis, one of the fields may request an interference value, such as a signal-to-noise ratio. An AI module may learn test-specific fields based on historical test data. Additionally, or alternatively, the test-specific fields may be set by the analyst and/or other team members.

Prior to conducting the test, the analyst may specify a type of test to be performed (e.g., conducted) in the laboratory. As described, different types of tests may be performed based on a project, a type of laboratory, and/or other factors. For example, the test is not limited to a specific scientific study. Aspects of the present disclosure contemplate any type of test. Based on the type of test, the ELN generates a template for receiving data.

The template may include one or more fields for receiving data corresponding to the test. For example, the data may include a table, plot, a recipe, raw data, instrument settings, test results, and/or the like. One or more additional fields may be provided for receiving handwritten notes corresponding to the test or the data. The data corresponding to the test may be input by the analyst and/or obtained from an instrument. The analyst may input the data and/or the handwritten notes via an electronic input device, such as an electronic pen. Data and/or notes may also be provided via a keyboard or other input device.

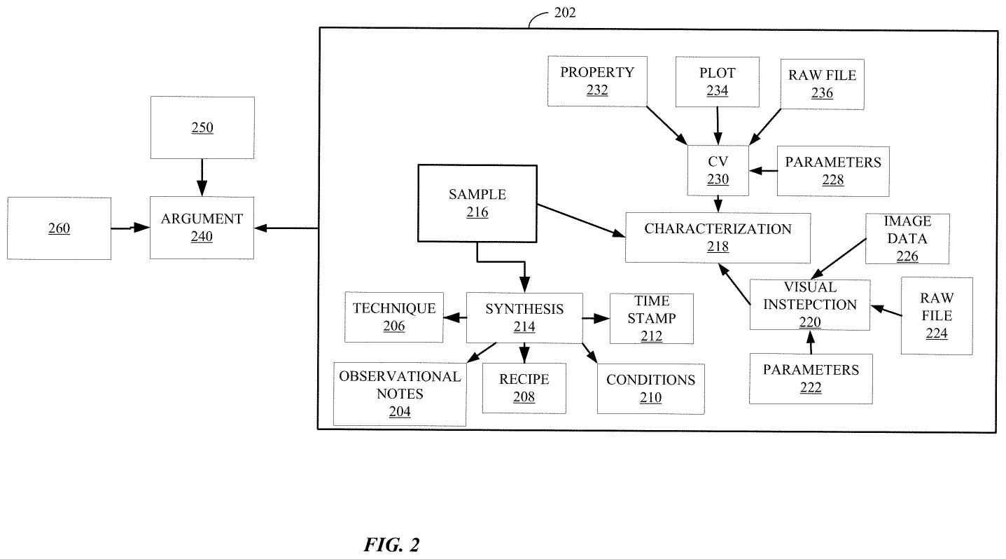

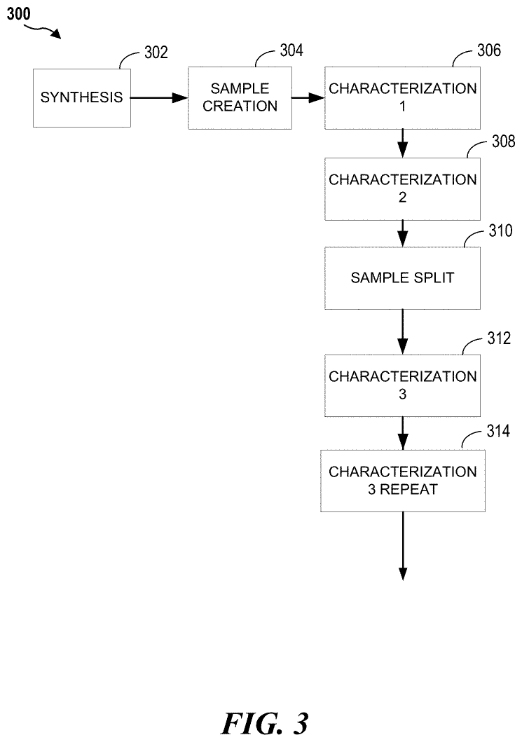

The received data and/or notes may be parsed to identify relevant information. Additionally, metadata may be parsed. As described, the electronic data platform may use protocol-specific parsers for parsing and saving notes to an appropriate format (e.g., table, plot, recipe for mixing, and/or the like). Data corresponding to a sample-based provenance, such as the sample-based provenance 200 as described in FIG. 2, and a time-based provenance, such as the time-based provenance as described in FIG. 3, may be identified from the parsed data. One or both of the time-based provenance or the sample-based province may be updated based on the identified data.

In one configuration, a model (e.g., machine learning model) generates an inference based on the data and one or more of the time-based provenance and the sample-based provenance. The template may be updated based on the inference. For example, the update may provide one or more messages for the analyst. As another example, the update may add one or more fields for input. The analyst may use the updated template for a subsequent test.

In one implementation, the inference corrects the data based on the time-based provenance, the sample-based provenance, and ambient condition information (for example, IoT data). The corrected data may include the notes and/or data corresponding to the test. The corrected data may be stored in the remote storage location. Additionally, the updated template may provide a message indicating the corrected data.

Additionally, or alternatively, the inference indicates whether the test succeeded or failed based on the parsed data and the sample-based provenance. The indication of the success or failure may be provided when the analyst does not provide the results of the test. The updated template may provide a message indicating one or more changes to a procedure of the test to yield success when the test failed. Additionally, the results of the test may be stored in the remote storage location when the test succeeded.

Additionally, or alternatively, the inference identifies a relationship between the test and another test based on a comparison of a topic model and at least one of the parsed data, the sample-based provenance, and/or the time-based provenance. As described below, the topic model may be generated during a training phase of the artificial neural network. The updated template may provide a message indicating one or more related tests, journals, papers, and/or the like.

Additionally, or alternatively, the inference identifies an update to an instrument setting based on the sample-based provenance. The instrument setting may be updated based on the inference. For example, the instrument setting may be updated via wireless communications exchanged between the instrument and the electronic data platform. The updated template may provide a message indicating the updated instrument setting. As another example, the electronic data platform may notify the analyst to update the instrument setting and to perform a subsequent test. In one configuration,

Additionally, or alternatively, the inference identifies a number of repeats for the test to obtain an effect based on a variance, the time-based provenance, and the sample-based provenance. The updated template may provide a message indicating the number of repeats to perform.

Additionally, or alternatively, the inference predicts a subsequent test based on the time-based provenance. The updated template may provide a message indicating the subsequent test to perform.

Additionally, or alternatively, the inference determines whether the data should be shared with a collaborator in the laboratory environment. The updated template may provide a message indicating the data should be shared. The artificial neural network (for example, AI module) may also generate an outline or a report for sharing with the collaborator.

As described above, in some implementations, the status function suggests material-specific instrument settings for a characterization test based on values in the report. The characterization experiment may be specified to measure one or more properties related to an element of a project. For example, for testing a battery, a characterization test may test voltage and/or resistance. As another example, for a network device, the characterization test may test, for example, a gain of the system, channel interference, and/or bandwidth. Aspects of the present disclosure may suggest, or automatically set, instrument settings for the specified characterization test.

At block 104, the analyst performs a new test for the project. For example, while reviewing the current project status provided at block 102, the analyst may have an idea for a new test. As an example, the test may be directed to synthesizing a new type of material. The analyst may write a brief plan in a paper notebook. As the analyst works on the new test, one or more sensors of the electronic data platform, such as IoT sensors, may collect environmental information, such as humidity and/or temperature. The environmental information may be continuously or periodically collected. Additionally, or alternatively, one or more sensors and/or network interfaces of the electronic data platform may collect data from one or more instruments performing the test.

After completing the test, the analyst may analyze the test results at the electronic data platform or another device in the lab. The analyst may store the results for further analysis. In one configuration, the results may be stored in a remote device. In one implementation, when storing the results, the results are registered with a result function of the project management system.

When registering the results, the analyst may store the results, upload a picture of handwritten notes, and/or provide other data corresponding to the test. The results function may also associate sensor data with the results. The sensor data may be correlated based on a time provided by the analyst and/or a time determined by the electronic data platform based on the data collected from the instruments performing the test. In some implementations, based on the gathered sensor data, the project management system may correct and/or append the test results and/or test notes. For example, if a test was performed at a temperature that is different from a conventional temperature for performing the test, the project management system may note that a rate of reaction for the current test is x times faster in comparison to conventional tests.

In some implementations, the electronic data platform may receive a test results file after the test(s) is complete. Based on a file extension of the test results, the project management system may suggest one or more analysis functions (e.g., analysis software) for analyzing the results.

In one configuration, the project management system tags the test as a success or failure based on natural language processing of lab notes, an analysis of equipment data, and/or an analysis of other test data. The test may be tagged as a success or failure in the absence of user input. A model of the AI module may tag the test as a success or failure.

In one configuration, the project management system provides an experiment planning and sampling rate analysis based on the test results. For example, the experiment planning and sampling rate analysis may identify a number of tests that should be repeated. As one example, experiment planning and sampling rate analysis may determine a number of repeats ‘N’ of a test (for example, synthesis) to obtain an effect of Y % for the test, where the test has a variance of X %. The effect of Y % may be a quantification of an improvement or an effect of a test (e.g., synthesis).

In some aspects, the project management system tracks one or more elements through a lifetime of tests. For example, a synthesized material may be tracked throughout its lifetime. The project management system may determine a causal connection between synthetic parameters (temperature (T), pressure (P), mixing rate), and the eventual measured outcomes (e.g., grain size and strength of ceramics, electrical resistance, etc.).

After performing the test (block 104), the analyst may request further collaboration with another team member (block 106). For example, the analyst may request a team member to perform a characterization on a sample. The analyst may request collaboration via a collaboration function of the project management system.

In the current example, in addition to specifying a type of additional test to be performed, the request may include sample information and/or notes. The request may be received at an ELN of the team member. The team member may perform additional tests based on the request. The team member may then add additional information to the report of the project. The additional information may include test results and additional documents. Furthermore, the team member's ELN may store raw instrument files from the instruments used to perform the tests. Instrument settings may be extracted from the raw instrument files and associated with measurements. Voltage is an example of an instrument setting. Each instrument may have one or more settings. Settings may be adjusted for a characterization.

The additional information provided by the team member may be stored in the remote storage, such that the analyst and/or additional team members may access the additional information. In one configuration, the analyst is notified when the requested test is completed and/or when the information corresponding to the requested test is stored in the remote device. The remote storage may also provide a central location for storing and updating standard operating procedures (SOP) for techniques in the lab.

In one configuration, the project management system links related characterizations. The linked characterizations may be searched based on a file extension, material composition, author, tags, and/or the like. In some aspects, the project management system may aid analysts in assigning, prioritizing, and tracking tasks in research collaborations.

The project management system may recommend additional tests (e.g., characterizations) based on a history of tests performed in the project and/or by the analyst. For example, based on an analysis sequence or steps of a test, the project management system recommends a subsequent characterization step. In such an example, the project management system may determine that the analyst performed the first test and may suggest performing a second test related to the first test.

In some implementations, the project management system provides a power analysis for test planning. For example, for a test (e.g., characterization), such as alternating current (AC) impedance spectroscopy, with a variance (X %), the project management system may determine a number of repeats (N) (for example, replicates) that should be performed to obtain a valid observation.

The project management system may also update distributions of measured quantities as more data is uploaded (e.g., reported) by analysts. An analyst may be informed if a newly measured value is different from expected values. The difference may be based on a statistical analysis. In some aspects, derived values may be updated based on measured quantities as new characterizations are received. Additionally, historical data may be used to generate material-specific sensitivity analysis of measured quantities (e.g., conductivity) to controllable (or uncontrollable) variables (e.g., temperature, impurity concentration).

For example, multiple conditions may be tested for a project. Still, all factors for a test may not be equal. The test results may be more sensitive to a first factor in comparison to a second factor. Therefore, it is desirable to have more data points for the first factor. The analyst may not be unaware of the increased sensitivity of the first factor. Thus, based on historical data, the project management system may automatically adjust a number of data points for one or more factors. For example, an experiment may provide data points for temperature and pressure. Based on historical data, the project management system may determine that, typically, pressure data points are not used for further analysis. Therefore, the project management system may optimize data points and/or the experiment based on historical data.

At a later time, the analyst may obtain various measurements for a set of samples previously registered with the project management system (block 108). The various measurements should be interpreted by the analyst. The project management system may provide previous interpretations of measurements (e.g., graphs) in response to a request from the analyst. The previous interpretations of measurements may expedite a current analysis process by refreshing the analyst's memory.

In the current example, the analyst may compare the current measurements with one or more previous measurements. To assist with the comparison (e.g., analysis), the analyst may retrieve information associated with the samples, such as lab notes. The information may be retrieved from the remote storage device via the analyst's ELN. The analyst may add notes to the interpretations, and these notes may be saved in the remote storage.

In one implementation, a graph generation function of the project management system may generate a graph based on measurements (e.g., data). The generated graph may provide, for each data-point, a record in lab notes associated with the measurements and/or metadata to facilitate data interpretation, such as root-cause analysis, outlier identification, and/or trend identification. The additional data may be provided in response to a user input (e.g., mouse click, mouse-over, etc.) on the data-point. The analyst may filter data points and/or graphs by a generation date, characterization data, author, operating conditions, and/or other conditions.

In some implementations, the project management system tracks a sample-based provenance and/or a time-based provenance of a workflow for a sample or an experiment within the project. The provenance refers to the order of actions for an experiment. The provenance may also refer to the materials, characterizations, methods, and/or analysis corresponding to a sample or an experiment. Each workflow may be versioned, such that different versions may be tracked. For example, in data science or artificial intelligence (AI) model training, a number of parameters may be adjusted to a desired level (e.g., optimized). As an example, in AI modeling, the parameters may be optimized to minimize a loss. In some cases, multiple workflows (decision trees) may generate results within a desired range of results. The workflows may include a series of parameter tuning steps with branching points. The project management system may track multiple workflows.

At one point in a project timeline, the analyst may share test results or analysis with a project teammate (block 110). The analyst may select relevant portions of the test results or the analysis via the ELN for sharing with the project teammate. The selected test results or analysis may be provided as a presentation. The teammate may review the presentation on their own ELN. Feedback may be provided from one ELN to another in the form of notes, attachments, comments, tracked changes, and/or other types of feedback.

In one configuration, the analyst may add annotations to plotted data points. The annotations may point out trends or anomalies in the graphed data. Relevant metadata or notes may be accessed through a live-graph object. In some implementations, analysts associated with a project may track progress filtered by a project or an analyst according to a desired level of detail (e.g., raw data, annotated plots, or slides). As described, one or more decision trees may be generated for a project. In one configuration, a decision tree is generated after a project is completed or at a stage in the project. The decision tree may be an after-the-fact decision tree showing what was tried, what did not work, what yielded desirable results, and/or the like, to aid with planning a project.

In some implementations, the project management system provides suggestions for sharing evidence and/or arguments with one or more collaborators. The suggestions may be based on a number of arguments, time spent on a project, and/or other factors.

After further research, the analyst may determine that it is time to present the current observations to the team as a whole. In one configuration, the project management system provides guidelines for this type of presentation (block 112). The project management system may provide questions presented during a previous presentation. The analyst may select relevant portions of a project report and export the relevant portions to a presentation. The project management system may generate the presentation based on the relevant portions. The presentations may be generated by an ANN of the AI module trained to generate presentations based on previous presentations. The analyst may grant the team access to the completed presentation as pre-read materials. During the meeting, the analyst may access any information stored in the remote storage device to provide any additional details. Attendees may ask questions and/or provide feedback via their own ELNs.

After the meeting, the analyst may access the project management system via the ELN to revisit the presentation and review comments added by the audience (block 114). The analyst may upload a picture of handwritten notes to be associated with the presentation.

Based on the feedback received from the presentation, the analyst may determine to publish the arguments in a journal. The project management system may assist in preparing a manuscript for publication. In one configuration, the project management system uses information associated with the project to generate a manuscript outline. The outline may include relevant arguments, evidence, and underlying details such as characterization settings. Information linked to the outline may be made public for peer review.

In one implementation, the project management system is trained on previous manuscript outlines. The training data may be experiment specific, such as manuscript outlines for wireless experiments or chemistry experiments. Alternatively, the training data include manuscript outlines from different types of experiments. After training, an artificial intelligence (AI) module of the ELN may gather the stored data to generate the manuscript. The AI module may include one or more of a character recognition module, a data analysis module, a data prediction module, and/or other modules.

As described, one or more functions performed by the project management system may be performed by an artificial intelligence (AI) module of the ELN. The AI module may assist analysts based on information associated with a project. The information may be captured by an ELN and stored in a remote storage device. In some implementations, the AI module may assist an analysis based on one or both of a sample-based provenance or a time-based provenance of a workflow for a sample or an experiment within the project.

FIG. 2 illustrates an example of a sample-based provenance 200 according to aspects of the present disclosure. As described, a provenance refers to the order of actions for an experiment, materials, characterizations, methods, and/or analysis corresponding to a sample or an experiment. The sample-based provenance 200 of FIG. 2 provides an example of information, such as the materials, analysis, and/or other data, which may be linked to a sample. The information that may be linked to a sample is not limited to the information shown in FIG. 2, additional and/or different information may be linked with a sample. The information may be based on a type of sample and/or a type of experiment.

As shown in FIG. 2, a first sample 216 is linked to a synthesis condition 214 and characterization data 218. Multiple sample-based provenances 200, 250, 260 may be linked with an argument 240. The argument 240 may be a scientific argument, such as all samples 200, 250, 260 generated with synthesis protocol A, exhibit behavior Y.

For ease of explanation, the sample-based provenance 200 is shown for the first sample 216. The sample-based provenances for the other samples 250, 260 may provide the same information as the sample-based provenance 200 for the first sample 216 and/or different information. Additionally, an argument 240 is not limited to linking three sample-based provenances 200, 250, 260, more or fewer sample-based provenances may be linked.

As described above, a sample 216 may be linked to the synthesis condition 214. The synthesis condition 214 refers to a condition for generating the sample 216. As shown in FIG. 2, the synthesis condition 214 may be associated with a timestamp 212, conditions 210, recipe 208, observational notes 204, and a technique 206. The technique 206 may be a type of synthesis method such as anionic living polymerization or sol-gel synthesis The conditions 210 may include environmental conditions (e.g., temperature, humidity, etc.), equipment settings, and/or other types of conditions. The recipe 208 may include materials and/or elements for synthesizing the sample 216.

Furthermore, the sample may be linked to characterization data 218. The characterization data 218 refers to one or more properties related to an element of a project. In the example of FIG. 2, the characterization data 218 includes visual inspection data 220 and cyclic voltammetry (CV) data 230. The visual inspection data 220 may include elements such as parameters 222, image data 226, and a raw file 224. The CV 230 may include elements such as a property 232, a plot 234, a raw file 236, and parameters 228.

FIG. 3 illustrates an example of a time-based provenance 300 of a workflow according to aspects of the present disclosure. A time-based provenance 300 may be generated for each workflow to record a process applied to a sample. An analyst may retrieve the time-based provenance 300 to determine an order of events for a sample. The sample may correspond to multiple workflows. As shown in FIG. 3, at block 302, a synthesis is initiated. The synthesis may include, for example, notes, a recipe, a timestamp, conditions, and/or a technique.

At block 304, the sample may be created. At block 306, a first characterization may be performed. For example, the first characterization may be based on nuclear magnetic resonance (NMR). As described, a characterization may measure one or more properties related to an element of a project. In the current example, the first characterization NMR determines the chemical structure of the sample. Other types of characterizations may be specified. At block 308, a second characterization may be performed. For example, the second characterization may be based on scanning electron microscopy (SEM). As an example, at block 310, the sample may be split. Splitting the sample refers to generating multiple instances of the sample to run different tests on each of the multiple instances. The different tests may be used to compare and contrast a behavior of the sample under different conditions.

Additionally, as shown in FIG. 3, at block 312, a third characterization may be performed. For example, the third characterization may be based on electrochemical impedance spectroscopy (EIS). At block 314, the third characterization may be repeated to confirm the findings of a previous characterization.

In one configuration, the AI module may tag a test as a success or failure in the absence of user input. As an example, the test may be a synthesis to create a new material. The success or failure may be based on lab notes and/or the progress of a workflow. In one configuration, the AI module follows a sample-based provenance, such as the sample-based provenance 200 described with reference to FIG. 2, to track the progress of a sample.

A natural language processing module of the project management system may analyze the synthesis of the sample-based provenance. For example, the natural language processing module may process the recipe to learn the entities, such as actions (mixing, pouring, weighing), quantities (e.g., 57 mg), components (e.g., NaCl, polystyrene), as well as the order of actions for a synthesis. The AI module may be trained to classify a synthesis recipe as successful or unsuccessful based on the associated characterization of a sample. During testing, the AI module may receive a synthesis recipe and predict the synthesis as successful or unsuccessful.

In one configuration, when the synthesis is unsuccessful, the AI module may estimate a process for obtaining a successful synthesis. The estimation may be based on historical data of successful and/or unsuccessful tests (e.g., synthesis). The AI module may suggest changing an order of operations, adding or subtracting elements, tuning instruments, adjusting instrument settings, and/or other adjustments. The AI module may be trained on processing/formulation protocols in addition to, or alternate from, a synthesis.

In some implementations, the AI module may learn text embeddings to enable testing of claims (e.g., hypotheses) in new spaces and guide inference from data. Once sufficient data is available on the platform, the text corpus can be tokenized, and natural language processing can be applied to tasks such as named entity recognition, topic segmentation, and learning text embeddings. These text embeddings provide a measure of similarity between a user-input and what is known from existing data. For example, a new researcher can provide an input, “Strontium titanate substrates for catalysts.” The text embeddings may be used by the platform to parse past records, and obtain closest matches to the user-input. If a match is not found, the user's input may be different from data and inputs processed by the platform. If a match is found, the user can select the record to view relevant experimental details.

For example, an analyst initiates a new project to prove a claim (e.g., hypotheses). In conventional systems, the analyst may read a corpus of journals to determine if the research, or similar research, was previously performed. This process may be time consuming. In one configuration, the AI module accumulates a corpus of data, such as journals, articles, research papers, thesis projects, and/or the like and processes the data via natural language processing. The AI module may perform topic modeling (e.g., learning keywords). The analyst provides hypotheses and/or keywords to the AI module. The AI module provides relevant data, such as projects, based on a similarity between the keywords and keywords of the returned data. That is, the AI module may determine if a similar project has been previously performed based on the topic modeling. Additionally, or alternatively, based on the results of other projects, the AI model may predict the success or failure of the hypotheses.

In such implementations, the AI module may use a time-based provenance, such as the time-based provenance 300 described with reference to FIG. 3, and a sample-based provenance, such as the sample-based provenance described with reference to FIG. 2. The time-based provenance and sample-based provenance may learn material embeddings and their relationship to specific keywords in the linked text data (e.g., synthesis, argument). As such, the AI module may learn relationships between previously unknown materials (for example, a polymer that has been studied for structural integrity has material properties similar to a polymer that has high ionic conductivity). In one configuration, the AI module may be initially trained offline on a corpus of journal articles to learn a representation of material property relationships. The trained offline model may be transferred to the project management system for further refinement.

In one implementation, the AI module may suggest material-specific instrument settings for an experiment based on values stored in a database. In such an implementation, the AI module may be based on a sample-based provenance, such as the sample-based provenance described with reference to FIG. 2. The AI module may be trained on data of inputs (e.g., sample composition/material, associated characterizations, and a purpose of the project) and an associated parameter set. A parameter set may be defined by all related instrument settings (e.g., voltage, scan rate, etc). The trained function suggest material-specific instrument settings for an experiment (e.g., what parameters should be used in a scanning electron microscope).

Additionally, or alternatively, in another implementation, the AI module may correct resulting data and notes. The correction may be based on IoT data. In such an implementation, the AI module may use a time-based provenance, such as the time-based provenance 300 described with reference to FIG. 3, and a sample-based provenance, such as the sample-based provenance described with reference to FIG. 2. The time-based provenance and sample-based provenance may propagate corrections to analyses linked to a specific sample that is linked to the IoT data. The corrections may be based on known explicit relationships (e.g., the reaction rate follows an Arrhenius relationship, and therefore T is an explicit input parameter here) and implicit relationships (e.g., the reaction rate is dependent on viscosity, which is linked to both measurement temperature and its intrinsic glass transition temperature).

Additionally, or alternatively, in yet another implementation, the AI module may recommend the next characterization method based on user history. In such an implementation, the AI module may use a time-based provenance, such as the time-based provenance 300 described with reference to FIG. 3. Based on a collection of time-based provenance for all experiments saved within the database, the AI module may be trained to learn the order of events for a specific set of inputs (e.g., sample, compositional information about a sample, and/or a purpose of a project). This trained algorithm may recommend the next characterization method.

Additionally, or alternatively, the AI module may suggest when to share evidence (e.g., arguments) with collaborators. In such an implementation, the AI module may use a time-based provenance, such as the time-based provenance 300 described with reference to FIG. 3. A time-based provenance may include multiple events that occur during the life of the project. One of the events may include a date or condition when data was shared with collaborators. Based on the order of events in the time-based provenance, an AI module may be trained on inputs (project, number of samples within a project, number of experiments) to predict outputs (amount of time passed between initiation of project and sharing, event of sharing). The trained algorithm is used to recommend sharing based on the number of characterizations, workflows, and the amount of time that has passed.

Additionally, or alternatively, the AI module may automate a power-analysis to determine the number of samples to measure. Experimental studies are frequently under-powered due to inadequate sample-size—which is hard to determine in the absence of sufficient structured data. The availability of sample-tables and characterization data from all the users of the platform allows a determination of the baseline variance in measurement. Using this, and the number of samples a user intends to measure, the minimum statistically significant effect size that can be quantified will be suggested to the user.

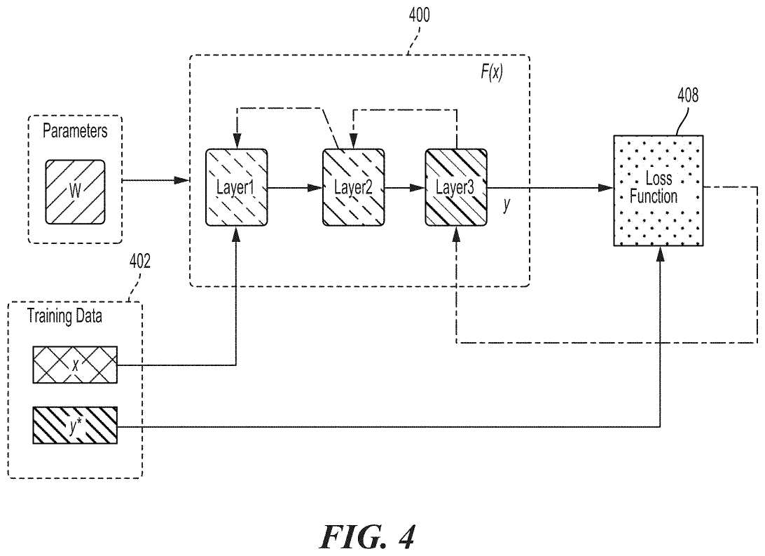

As described, the AI module may be trained offline. Additionally, the AI module may be updated (e.g., re-trained) online as more training data is acquired. FIG. 4 illustrates a flow diagram for training a model 400 according to aspects of the present disclosure. In one configuration, training data 402 may be stored at a data source, such as a server. During training, a set of samples are selected from the training data 402. The set of samples includes input data x, such as simulated data and/or real world data. Additionally, the set of samples includes ground truth labels y* corresponding to the input data x. In the present example, the training data may include data from previous experiments, such as time-based provenances (such as a time-based provenance 300 as described in FIG. 3), sample-based provenances (such as a sample-based provenance 200 as described in FIG. 2), lab notes, test results, publications, and/or other information as described above.

The model 400 may be initialized with a set of parameters w. The parameters may be used by layers of the model 400, such as layer 1, layer 2, and layer 3, of the model 400 to set weights and biases. The model 400 may be based on a function FO. The output y may be an inference, such as predicting whether a test was a success or failure. Aspects of the present disclosure are not limited to using one model 400, multiple instances of the model 400 may be trained to perform different tasks, such as the different inferences described with reference to FIGS. 1, 5, and 6.

The output of the model 400 is received at a loss function 408. The loss function 408 compares the output y to the ground truth label y*. The error is the difference (e.g., loss) between the transformed output y or non-transformed output y and the ground truth label y*. A gradient of the error may be used to update parameters of the model 400.

FIG. 5 is a diagram illustrating an example of a hardware implementation for an electronic data platform component 500 implementing a project management system, according to aspects of the present disclosure. The component 500 may be a component of a tablet device, user equipment (UE), laptop, desktop, or another type of computing device. For example, as shown in FIG. 5, the component 500 is a component of a tablet 528. Aspects of the present disclosure are not limited to the component 500 being a component of the tablet 528. Additionally, as described, the electronic data platform may be implemented on a number of components in a variety of environments.

The component 500 may be implemented with a bus architecture, represented generally by a bus 550. The bus 550 may include any number of interconnecting buses and bridges depending on the specific application of the component 500 and the overall design constraints. The bus 550 links together various circuits including one or more processors and/or hardware modules, represented by a processor 520, a communication module 522, a location module 518, a sensor module 502, an acceleration module 526, and a computer-readable medium 515. The bus 550 may also link various other circuits such as timing sources, peripherals, voltage regulators, and power management circuits, which are well known in the art, and therefore, will not be described any further.

The component 500 includes a transceiver 516 coupled to the processor 520, the sensor module 502, an AI module 508, the communication module 522, the location module 518, the acceleration module 526, and the computer-readable medium 515. The transceiver 516 is coupled to an antenna 555. The transceiver 516 communicates with various other devices over one or more communication networks, such as an infrastructure network, a local area network, a wide area network, a cellular communication network, or another type of network. As an example, the transceiver 516 may transmit received data to a remote storage device for storage.

The component 500 includes the processor 520 coupled to the computer-readable medium 515. The processor 520 performs processing, including the execution of software stored on the computer-readable medium 515 providing functionality according to the disclosure. For example, the processor 520, working in conjunction with one or more of the modules 502, 508, 515, 516, 518, 520, 522, 526, may execute the software to causes the component 500 to perform the various functions described with reference to FIGS. 1A, 1B, 2-4 and 6. The computer-readable medium 515 may also store data that is manipulated by the processor 520 when executing the software.

The sensor module 502 may be used to obtain measurements via different sensors, such as a first sensor 506 and a second sensor 505. The first sensor 506 may be a temperature sensor, humidity sensor, and/or another type of environmental sensor. The second sensor 505 may be an environmental sensor or another type of sensor, such as a motion sensor. Of course, aspects of the present disclosure are not limited to the aforementioned sensors as other types of sensors, such as, for example, thermal, sonar, and/or lasers are also contemplated for either of the sensors 505, 506.

The measurements of the first sensor 506 and the second sensor 505 may be processed by one or more of the processor 520, the sensor module 502, the AI module 508, the communication module 522, the location module 518, the acceleration module 526, in conjunction with the computer-readable medium 515 to implement the functionality described herein. In one configuration, the data captured by the first sensor 506 and the second sensor 505 may be transmitted to an external device via the transceiver 516. The first sensor 506 and the second sensor 505 may be coupled to the tablet 528 or may be in communication with the tablet 528.

The location module 518 may be used to determine a location of the tablet 528. For example, the location module 518 may use a global positioning system (GPS) to determine the location of the tablet 528. The communication module 522 may be used to facilitate communications via the transceiver 516. For example, the communication module 522 may be configured to provide communication capabilities via different wireless protocols, such as WiFi, long term evolution (LTE), 5G, IoT, etc. The communication module 522 may also be used to communicate with other components of the tablet 528 that are not modules of the component 500.

The acceleration module 526 may be used to determine motion of the tablet 528. As an example, the acceleration module 526 may include an accelerometer. The acceleration module 526 may work in conjunction with the location module 518 to determine a location of the ELN in relation to equipment in a lab.

The AI module 508 work in conjunction with the processor 520, the communication module 522, the location module 518, the acceleration module 526, and/or the computer-readable medium 515. The AI module 508 may be configured to perform operations including operations of the process 800 described below with reference to FIG. 5. For example, the AI module 508 may be configured to generate an inference based on one or more of the time-based provenance and the sample-based provenance. In one implementation, the inference corrects the data based on the time-based provenance, the sample-based provenance, and the ambient condition information. In another implementation, the inference indicates whether the test succeeded or failed based on the parsed data and the sample-based provenance.

In another implementation, the inference identifies a relationship between the test and another test based on a comparison of a topic model and at least one of the parsed data, the sample-based provenance, the time-based provenance. In yet another implementation, the inference identifies an update to an instrument setting based on the sample-based provenance. In another implementation, the inference identifies a number of repeats for the test to obtain an effect based on a variance, the time-based provenance, and the sample-based provenance.

In still another implementation, the inference may predict a subsequent test based on the time-based provenance, and the method further comprises updating the template to provide a message indicating the subsequent test. In another implementation, the inference may determine whether data should be shared with a collaborator in the laboratory environment.

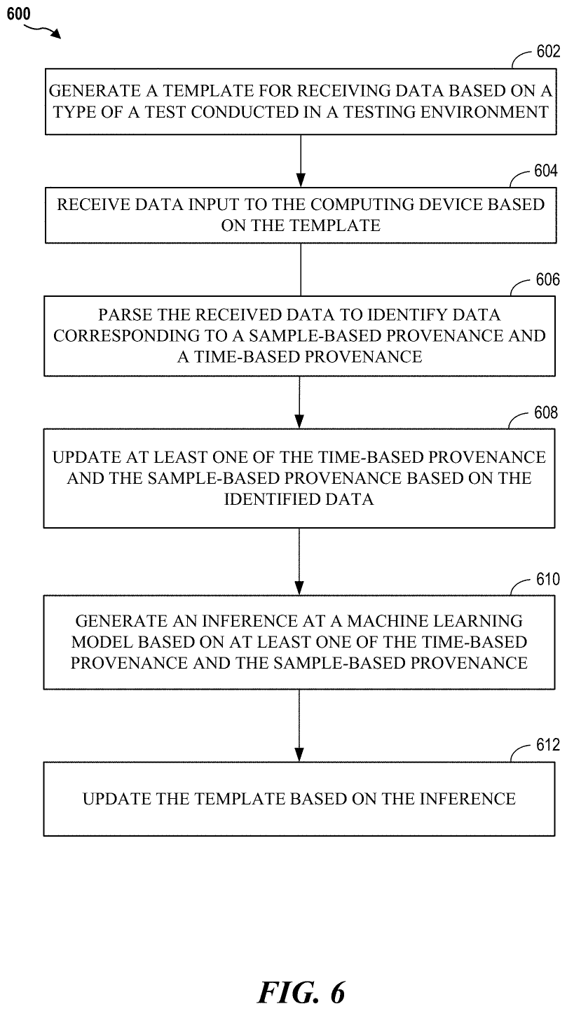

FIG. 6 illustrates a diagram illustrating an example process 600 in accordance with aspects of the present disclosure. The example process 600 may be performed by one or more components of an electronic data platform. As an example, the process 600 is performed by an ELN, such as the ELN 150 or 528 described with reference to FIGS. 1A and 5. As shown in FIG. 6, at block 602, the process 600 generates a template for receiving data based on a type of a test conducted in a testing environment. Aspects of the present disclosure are not limited to a laboratory environment. Other environments are contemplated.

As shown in FIG. 6, at block 604, the process 600 receives data input to the computing device based on the template. The template may be a template 152 shown in FIG. 1A. As described, the template may be customized based on an environment, a type of test, and/or other factors.

Additionally, at block 606, the process 600 may parse the received data to identify data corresponding to a sample-based provenance and a time-based provenance. Furthermore, at block 608, the process 600 may update one or more of the time-based provenance and the sample-based provenance based on the identified data. At block 610, the process 600 may generate an inference at a machine learning model based on one or more of the time-based provenance and the sample-based provenance. The machine learning model may be an artificial neural network or another type of model. At block 612, the process 600 updates the template based on the inference.

Based on the teachings, one skilled in the art should appreciate that the scope of the present disclosure is intended to cover any aspect of the present disclosure, whether implemented independently of or combined with any other aspect of the present disclosure. For example, an apparatus may be implemented or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses or objectives. Rather, aspects of the present disclosure are intended to be broadly applicable to different technologies, system configurations, networks and protocols, some of which are illustrated by way of example in the figures and in the following description of the preferred aspects. The detailed description and drawings are merely illustrative of the present disclosure rather than limiting, the scope of the present disclosure being defined by the appended claims and equivalents thereof.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor specially configured to perform the functions discussed in the present disclosure. The processor may be a neural network processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. Alternatively, the processing system may comprise one or more neuromorphic processors for implementing the neuron models and models of neural systems described herein. The processor may be a microprocessor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or such other special configuration, as described herein.

The steps of a method or algorithm described in connection with the present disclosure may be embodied directly in hardware, in a software module executed by a processor, or in a combination of the two. A software module may reside in storage or machine readable medium, including random access memory (RAM), read only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computer. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The machine-readable media may comprise a number of software modules. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any storage medium that facilitates transfer of a computer program from one place to another.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means, such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method performed by a computing device, comprising:
generating a template for receiving data based on a type of a test conducted in a testing environment;
receiving data input to the computing device based on the template;
parsing the received data to identify data corresponding to a sample-based provenance and a time-based provenance;
updating at least one of the time-based provenance and the sample-based provenance based on the identified data;
generating an inference at a machine learning model based on at least one of the time-based provenance and the sample-based provenance; and
updating the template based on the inference.

2. The method of claim 1, in which:
the template provides at least one a first field for numerical data corresponding to the test, a second field for handwritten notes corresponding to the test, or a combination thereof; and
the handwritten notes received via an input to a touchscreen of the computing device.

3. The method of claim 1, further comprising:
receiving instrument settings from an instrument for performing the test;
receiving ambient condition information from an ambient condition sensor in the laboratory environment; and
updating at least one of the time-based provenance and the sample-based provenance based on the instrument settings and the ambient condition information.

4. The method of claim 3, in which the inference corrects the data based on the time-based provenance, the sample-based provenance, and the ambient condition information, and the method further comprises:
storing the corrected data; and
updating the template to provide a message indicating the corrected data.

5. The method of claim 1, in which the inference indicates whether the test succeeded or failed based on the parsed data and the sample-based provenance, and the method further comprises:
updating the template to provide a message indicating at least one change to a procedure of the test to yield success when the test failed; and
storing a result of the test when the test succeeded.

6. The method of claim 1, in which:
the inference identifies a relationship between the test and another test based on a comparison of a topic model and at least one of the parsed data, the sample-based provenance, the time-based provenance, or a combination thereof; and
the topic model generated during a training phase of the artificial neural network; and further comprising updating the template to provide a message indicating at least one related test.

7. The method of claim 1, in which the inference identifies an update to an instrument setting based on the sample-based provenance, and the method further comprises:
updating at least one instrument setting based on the inference; and
updating the template to provide a message indicating the updated instrument setting.

8. The method of claim 1, in which the inference identifies a number of repeats for the test to obtain an effect based on a variance, the time-based provenance, and the sample-based provenance, and the method further comprises:
updating the template to provide a message indicating the number of repeats.

9. The method of claim 1, in which the inference predicts a subsequent test based on the time-based provenance, and the method further comprises updating the template to provide a message indicating the subsequent test.

10. The method of claim 1, in which the inference determines the data should be shared with a collaborator in the laboratory environment, and the method further comprises updating the template to provide a message indicating the data should be shared.

11. An apparatus, comprising:
a processor;
a memory coupled with the processor; and
instructions stored in the memory and operable, when executed by the processor, to cause the apparatus:
to generate a template for receive data based on a type of a test conducted in a testing environment;
to receive data input based on the template;
to parse the received data to identify data corresponding to a sample-based provenance and a time-based provenance;
to update at least one of the time-based provenance and the sample-based provenance based on the identified data;
to generate an inference at a machine learning model based on at least one of the time-based provenance and the sample-based provenance; and
to update the template based on the inference.

12. The apparatus of claim 11, in which:
the template provides at least one a first field for numerical data corresponding to the test, a second field for handwritten notes corresponding to the test, or a combination thereof; and
the handwritten notes received via an input to a touchscreen of the computing device.

13. The apparatus of claim 11, in which the instructions further cause the apparatus:
to receive instrument settings from an instrument for performing the test;
to receive ambient condition information from an ambient condition sensor in the laboratory environment; and
to update at least one of the time-based provenance and the sample-based provenance based on the instrument settings and the ambient condition information.

14. The apparatus of claim 13, in which the inference corrects the data based on the time-based provenance, the sample-based provenance, and the ambient condition information, and further comprising:
storing the corrected data; and
updating the template to provide a message indicating the corrected data.

15. The apparatus of claim 11, in which the inference indicates whether the test succeeded or failed based on the parsed data and the sample-based provenance, and the instructions further cause the apparatus:
to update the template to provide a message indicating at least one change to a procedure of the test to yield success when the test failed; and
to store a result of the test when the test succeeded.

16. The apparatus of claim 11, in which:
the inference identifies a relationship between the test and another test based on a comparison of a topic model and at least one of the parsed data, the sample-based provenance, the time-based provenance, or a combination thereof;
the topic model generated during a training phase of the artificial neural network; and
the instructions further cause the apparatus to update the template to provide a message indicating at least one related test.

17. The apparatus of claim 11, in which the inference identifies an update to an instrument setting based on the sample-based provenance, and
the instructions further cause the apparatus:
to update at least one instrument setting based on the inference; and
to update the template to provide a message indicating the updated instrument setting.

18. The apparatus of claim 11, in which the inference identifies a number of repeats for the test to obtain an effect based on a variance, the time-based provenance, and the sample-based provenance, and
the instructions further cause the apparatus to update the template to provide a message indicating the number of repeats.

19. The apparatus of claim 11, in which the inference predicts a subsequent test based on the time-based provenance, and further comprising updating the template to provide a message indicating the subsequent test.

20. A non-transitory computer-readable medium having program code recorded thereon, the program code executed by a processor and comprising:
program code to generate a template for receive data based on a type of a test conducted in a testing environment;
program code to receive data input based on the template;
program code to parse the received data to identify data corresponding to a sample-based provenance and a time-based provenance;
program code to update at least one of the time-based provenance and the sample-based provenance based on the identified data;
program code to generate an inference at a machine learning model based on at least one of the time-based provenance and the sample-based provenance; and
program code to update the template based on the inference.
